(19) United States
(12) Patent Application Publication
(10) Pub. No.: US 2015/0313211 A1
(43) Pub. Date: Nov. 5, 2015

(54) A Method of Vitrification

(71) Applicant: NEOBIOS PTE. LTD., Singapore (SG)

(72) Inventors: Soon Chye Ng, Singapore (SG); Gábor Vajta, Queensland (AU)

(21) Appl. No.: 14/650,151

(22) PCT Filed: Dec. 3, 2013
(86) PCT No.: PCT/SG2013/000512

§ 371 Date: Jun. 5, 2015

(30) Foreign Application Priority Data
Dec. 5, 2012 (SG) 201209017-1

(51) Int. Cl. A01N 1/02

(52) U.S. Cl. CPC A01N 1/0284; A01N 1/0221

(57) ABSTRACT

The present invention relates to a vitrification method. In particular, the present invention relates to a method of producing at least one vitrified cell comprising loading a cell into a holding space in at least one conduit; providing at least one cryoprotectant to the holding space of the conduit in increasing concentrations, wherein the cryoprotectant is capable of equilibrating the cell; cooling the cell in the holding space of the conduit to produce a vitrified cell; and storing and maintaining the vitrified cell in the holding space of the conduit.

### FIELD OF INVENTION

The present invention relates to a vitrification method. In particular, the present invention relates to a method and a device for producing at least one vitrified cell for cryogenic preservation of cells such as embryos, oocytes and spermatozoa using a single platform.

### BACKGROUND TO THE INVENTION

Vitrification, which is a method of crystal-free solidification of solutions at low temperatures, is a phenomenon that has been exploited for ages in many industries such as for example in glass and/or cotton candy production. Vitrification in embryology is a highly efficient approach to cryopreserve oocytes and embryos in samples where both the extracellular and intracellular solution vitrifies. Vitrification was successfully applied for cryopreservation of mouse embryos in 1985but for a long period after, it was regarded as a curiosity without practical significance. Commercial application of vitrification in domestic animals only started 15 years ago and since then there has only been moderate advancement in the technology.

Approximately 5 years ago vitrification started to replace traditional freezing for all stages of preimplantation embryos, and oocytes in human beings. The number of embryos that have been vitrified and warmed/transferred later may be estimated to be more than 300,000 (around 10,000 to 20,000 for oocytes), and the numbers are rapidly growing worldwide. The application of vitrification opens new possibilities in the field of human reproduction including single blastocyst transfer, trophectodermal biopsy, thorough genomic analysis of the sample and the like. Oocyte vitrification has also enormously increased the possibilities of fertility preservation of women, decreasing the gap between genders in this issue.

In recent years, vitrification has been one of the most important topics of Human Assisted Reproductive Technology (ART) conferences and papers. In the foreseeable future, vitrification will most probably be the exclusive procedure used by human ART Units worldwide. The market is enormous. IVF Worldwide, a mailing list has 3,300 registered In-Vitro Fertilization (IVF) clinics, but the real number is most probably above 5,000 and growing every day. The ability to cryopreserve oocytes, embryos, sperm and other similar biological specimens is critical to the widespread application of assisted reproductive technologies. However, due to the large volume of the cells and the high chilling sensitivity of oocytes and early embryos, cryopreservation techniques are not well developed in most species.

Traditionally, embryos are cryopreserved using “slow freezing techniques”. Low concentrations of cryoprotectants and slow controlled rates of cooling slowly dehydrate the cell during freezing to prevent intracellular crystallization. Because of this, cryopreservation of oocytes, embryos and other developmental cells using such procedures results in a reduced ability to both establish and maintain pregnancy following transfer. Oocytes are particularly susceptible to cryopreservation damage because of disruption of the metaphase spindle microtubule integrity during cooling.

Alternative prior cryopreservation methods have relied on vitrification with high concentrations of cryoprotectants, which when rapidly cooled result in a glass-like state. However, a disadvantage of this vitrification technique is that the cryoprotectants are very toxic to oocytes, embryos and other delicate developmental cells. Cryoprotectant toxicity can be minimized by increasing the cooling rate, which has been accomplished by plunging oocytes held on electron microscopy grids, or within thinly walled straws (known as open pulled straw) directly into liquid nitrogen. However, both of these procedures are cumbersome and recovery of embryos is problematic. Also, embryologists work with extremely primitive handheld tools, homemade containers and ad-hoc technical solutions. This is not only against the work-safety regulations (handling of liquid nitrogen requires a very special care, protective clothes, gloves and goggles, none of them can be worn during embryo or oocyte vitrification), but is also a source of extreme inconsistency and compromised results. Moreover, in sharp contrast to the low-technology procedure, the tools and media are extremely expensive hampering the widespread application of vitrification.

Therefore a need remains for a method for the vitrification of a biological specimen which is able to maximize the cooling rate of the cells of the specimen; maintain viability of the specimen during vitrification and subsequent thawing; prevent mechanical stress to the specimen; and provide ease of manipulations during cryopreservation and recovery.

### SUMMARY OF THE INVENTION

The present invention is defined in the appended independent claims. Some optional features of the present invention are defined in the appended dependent claims.

The present invention seeks to address at least one of the problems in the prior art and may provide an improved method of vitrification. According to one aspect of the invention, there is provided a method of producing at least one vitrified cell comprising:
loading a cell into a holding space in at least one conduit;
providing at least one cryoprotectant to the holding space of the conduit in increasing concentrations, wherein the cryoprotectant is capable of equilibrating the cell;
cooling the cell in the holding space of the conduit to produce a vitrified cell; and
storing and maintaining the vitrified cell in the holding space of the conduit.

According to a further aspect of the invention, there is provided a device capable of vitrification of at least one cell, the device comprising:
at least one conduit comprising at least one holding space adapted to hold at least one cell;
means for providing at least one fluid to enter the holding space;
means for allowing the fluid to leave the holding space; and
means to maintain the cell within the holding space when the fluid flows through the holding space.

As will be apparent from the following description, specific embodiments of the present invention allow the vitrification of at least one biological specimen using a different method of vitrification that may be efficient and/or effective. This and other related advantages will be apparent to skilled persons from the description below.

### BRIEF DESCRIPTION OF THE FIGURES

FIG. 1 shows the basic components and actions that take place during cooling and the movements are inverse during warming in the method of vitrification

FIG. 2 is a schematic diagram of the steps involved in equilibration and dilution in the vitrification method of the present invention

### DETAILED DESCRIPTION

Bibliographic references mentioned in the present specification are for convenience listed in the form of a list of references and added at the end of the examples. The whole content of such bibliographic references is herein incorporated by reference.

Reference to an element by the indefinite article “a” or “an” does not exclude the possibility that more than one of the element is present, unless the context clearly requires that there be one and only one of the elements. The indefinite article “a” or “an” as used herein thus usually means “at least one”.

The term “comprising” and its conjugations is used in its non-limiting sense to mean that items following the word are included, but items not specifically mentioned are not excluded. Accordingly, the term “comprising” encompasses the more restrictive terms “consisting essentially of” and “consisting of.”

The term “cryopreservation” as used herein refers to the preservation of a biological specimen at extremely low temperature.

The term “developmental Cells” as used herein refers to a reproductive body of an organism that has the capacity to develop into a new individual organism capable of independent existence. Developmental cells include, but are not limited to, sperm, oocytes, embryos, morulae, blastocysts, and other early embryonic cells.

The term “freezing material” as used herein refers to any material, including but not limited to, liquid gases such as liquid nitrogen, liquid propane, liquid helium or ethane slush, which are capable of causing vitrification of a biological material.

The term “viable” as used herein refers to a biological specimen which is able to live and develop normally for a period of time.

The term “vitrification (Vitrify)” as used herein refers a phenomenon wherein a biological specimen is rapidly cooled to very low temperatures such that the water in the specimen forms a glasslike state without undergoing crystallization.

The present invention provides an improved method and device for the cryogenic preservation of cells, from vitrification to cryogenic storage and eventually returning the vitrified cell to a viable non-vitrified state, for example for use in assisted reproduction.

According to one aspect of the invention, there is provided, a method of producing at least one vitrified biological specimen comprising:
loading a biological specimen into a holding space in at least one platform;
providing at least one cryoprotectant to the holding space of the platform in increasing concentrations, wherein the cryoprotectant is capable of equilibrating the biological specimen;
cooling the biological specimen in the holding space of the platform to produce a vitrified cell; and
storing and maintaining the vitrified biological specimen in the holding space of the platform.

The platform may be any form of a carrier tool within which the steps of the method may be carried out. In particular, the platform may refer to any structure comprising a holding space adapted to hold at least one cell, the structure being suitable for use in the method of the present invention. Suitable structures may include tubular structures open on one or both ends, planar structures with microwells that serve as a holding space, lab-on-chip devices with microfluidic channels leading to holding spaces, and the like. In particular, the platform may be a conduit.

In particular, the conduit may be selected from the group consisting of heat-resistant straw, minitube straw, open pulled straw and the like. As used herein, “heat-resistant” refers to a straw that does not substantially deform when subjected to heating and/or cooling within the range of temperatures required for vitrification.

Particularly useful platforms suitable for the method according to any aspect of the present invention include the Open Pulled Straws provided in the OPS Sterile Kit commercially available at http://www.gaborvajta.com/the-open-pulled-straw-system/products/. Such platforms may comprise a tube with a wall thickness of less than 0.1 mm, and an internal diameter of between 0.6-0.9 mm, enabling the loading of the cells to take place via capillary action. Such platforms may through capillary action be able to draw a column of liquid of between 5-15 mm in diameter, but more typically the cells may be loaded in a volume of between 1-2 microlitres, which may then be considered the holding space for the cells. The tube may be made of thermoplastic, glass or other suitable materials for conducting heat between the holding space and a fluid used to cool and/or warm the holding space, for example liquid nitrogen and/or cell maintaining medium. Such platforms may also be open at one end, allowing the cooling and/or warming fluids to contact the holding space directly for more efficient heat transfer.

The biological specimen may be cooled by either coming in contact directly or indirectly with a freezing material. Upon exposure to the freezing material, the biological specimen undergoes vitrification. The biological specimen which has undergone vitrification may be stored for a period of time, and then thawed at a later date. The thawed biological specimen remains viable.

The present invention therefore has a number of uses. It may be used for animal husbandry, laboratory research, endangered species preservation, as well as for human assisted reproduction.

The biological specimen of the present invention can be any sort of viable biological specimen which is a living cell. In particular, the specimen may be at least one developmental cell, and more in particular mammalian developmental cell. Such cells can include, but are not limited to, sperm, embryos, blastocysts, morulae, and oocytes. Such cells can be from any desired mammalian source, including but not limited to: humans; non-human primates such as monkeys; laboratory mammals such as rats, mice and hamsters; agricultural livestock such as pigs, sheep, cows, goats and horses; and zoologically important and/or endangered animals, etc. The use of other developmental cells from other living creatures is also within the scope of this invention, such as reptiles, amphibians, and insects such as Drosophila. Other suitable cells for use with the present invention include both stem cells, including human stem cells, and plant tissue cells.

The biological specimen may first be taken up into the holding space of the carrier tool prior to vitrification. The carrier tool may be capable of holding the specimen during the different steps involved in vitrification and allowing the biological specimen to be cooled very quickly, thus allowing the biological specimen to vitrify rather than form ice crystals within the cell, which would in turn ultimately disrupt cell walls and other vital cellular constituents.

In one example, the use of a conduit allows for better handling of the biological specimen during the vitrification process, and thereby solves the problem of specimen recovery known in prior microscopy grid vitrification methods. The conduit may also directly or indirectly encircle and/or hold the biological specimen in place during the vitrification process, so that the biological material is not lost during the process. Therefore, the conduit does not just allow the biological specimen to rest upon it, as with flat sheets or microscopy grids, but may actually help keep the specimen in place, via strong adhesion forces which surround the biological specimen, or medium, solution or material containing the specimen. In particular, the conduit may have an appropriate size and shape to allow the vitrified biological specimen to be cryopreserved therein. It has been surprisingly and unexpectedly discovered that the use of a conduit in the present vitrification methodology allows fast cooling rates, ease of visualization, facile manipulations and a high success rate of viability when the vitrified specimen is thawed and cultured.

The holding space may be a space within the conduit. In particular, the holding space may be of a suitable size to hold the cell(s) and allow the cells to come in contact with the cryoprotectant. The holding space may be less than about 10 microlitres. In particular, the holding space may be less than about 9, 8, 7, 6, 5, 4, 3, 2 or 1 microlitres.

The biological specimen may be treated with a small amount of a cryoprotectant prior to vitrification in increasing concentrations to equilibrate the cell. The providing of cryoprotectant in increasing concentrations to the holding space may be done in a stepwise or continuous manner. In particular, this may be done in a continuous manner. The continuous instead of stepwise equilibration and dilution of solutions may be done using a tube, a filter trap for the samples and a mixture of slowly moving solution with continuously changing composition. This is almost impossible by hand, but can be precisely regulated using the method of the present invention, providing an extremely mild change instead of the usual drastic stepwise equilibration and dilution procedures. Further, the biological samples may be exposed to a pre-mixed solution of cryoprotectants that slowly flows around, and the concentration of the mixture is continuously changing before it reaches the embryos, this provides extremely high accuracy.

The methodology of the present invention also allows for a decrease in the time of exposure of the biological specimen to the solution phase of the cryoprotectant used, thus lowering the toxicity of the cryoprotectant to the biological specimen. Cryoprotectants suitable for use in the method of the invention may be any water-soluble or partially water-soluble compound or mixture of compounds that may be solidified by cooling in the presence of water without crystal formation. Suitable cryoprotectants may be permeable cryoprotectants, non-permeable cryoprotectants or a combination thereof. Cryoprotectants, such as ethylene glycol (EG), polyethylene glycol, dimethyl sulfoxide (DMSO), propylene glycol, glycerol, methyl-formamide, propane diol, sugars, sucrose, trehalose and methyl pentane diol, as well as others well known in the art, can be toxic to sensitive cells such as oocytes and embryos especially when used in large dosages or high concentrations during cryopreservation. The present invention allows for the use of a cryoprotectant to be present in solution phase in the presence of the biological specimen for a short time period such that toxicity to the specimen is minimized. Suitable cryoprotectants may also comprise compounds which may aid vitrification or cryopreservation of the cell but may not be considered cryoprotectants in themselves. For example, some suitable cryoprotectants may further comprise amide compounds which may assist vitrification by other cryoprotectants.

By allowing for quick cooling times, reduced time of exposure of solution phase cryoprotectants, and reliable retention and manipulation of the biological specimen, the present invention solves a long standing problem in the art of successful cryopreservation of sensitive biological specimens such as developmental cells

The principles for cooling may be considered to be:

1. No manual intervention after a simple loading into the carrier tool

2. Controllable equilibration parameters exposing the sample to continuously increasing concentration of cryoprotectants (such as EG, DMSO, sucrose)

3. Immersion of the tool into pre-sterilized liquid nitrogen

4. Package of the carrier tool into a pre-cooled sterile container and proceeding to storage

The holding space of the conduit may be capable of being used for thawing the vitrified cell to a viable cell. In particular, thawing comprises the steps of:
warming the vitrified cell in the holding space of the conduit; and
providing at least one diluent to the holding space of the conduit in increasing concentrations, wherein the diluent is capable of equilibrating the cell and decreasing the concentration of the cryoprotectant.

The fact that the tool used for equilibration and/or dilution is at the same time the carrier for the sample at vitrification and storage makes the method easy to use and more affordable. Also, with less movement of the biological specimen from one holding space to another during the method of vitrification, there may be less damage to the biological specimen.

The present methodology allows for the cryopreservation of biological specimens which in the past had resisted efforts of cryopreservation to result in a useful percentage of viable preserved specimens. At least 25, 30, 35, 40, or 45 percent, and more in particular, 50, 55, 60, 65, 70, 75, 80, 85, 90, 95 percent, of the vitrified embryos will be viable after being thawed and cultured.

The conduit containing the biological specimen may at the cooling stage be quickly placed directly or indirectly in contact with freezing material, such that the biological specimen is exposed to the cold, allowing vitrification of the biological specimen as soon as possible after equilibration. For example, the time period between exposing the biological specimen on the conduit to cryoprotectant and the placement of the biological specimen in contact with the freezing material may be less than about 150 sec. In particular, this time period may be less than about 120, 110, 100, 90, 80, 70, 60, 50, 40, 30 sec. In particular, this time period may be from about 120 sec. to about 30 sec., from about 100 sec. to about 35 sec., from about 80 sec. to about 40 sec., from about 60 sec. to about 45 sec.

The freezing material may be liquid nitrogen, ethane slush, or any other freezing material well known in the art. In particular, the biological specimen may be held within the freezing material during all manipulations subsequent to vitrification, until the specimen is to be thawed.

The vitrified biological specimen may then be maintained within the conduit for storage. In Thereafter, the biological specimen may be thawed, and the viable biological specimen may be further developed. Thawing may be accomplished by removing the conduit from any storage tank in which it resides, and quickly warming the vitrified cell in the holding space of the conduit. The vitrified cell may be directly or indirectly in contact with a thawing liquid. The cell may then come in contact with at least one thawing liquid to the holding space of the conduit in increasing concentrations, wherein the thawing liquid may be capable of equilibrating the cell and decreasing the concentration of the cryoprotectant. Providing of diluent in increasing concentrations to the holding space may be done in a stepwise or continuous manner.

The thaw solution may be any solution, material or diluent that is sufficient to allow the biological specimen to thaw while preserving its viability, including but not limited to, media known in the art that is appropriate as a base medium for the particular biological specimen. After thawing, the biological specimen can be further manipulated in any appropriate manner known for the species and process for which the specimen is being utilized. Diluents suitable for use in the method of the invention may be any water-soluble or partially water-soluble compound or mixture of compounds that comprises a lower concentration of cytotoxic cryoprotecting compounds than is present in the holding space. For example, common holding media known to a skilled person as being suitable for maintaining cells may be provided to the holding space so as to reduce the concentration of the cryoprotectant in the holding space, thereby reducing the cytotoxicity of the cell environment and returning the cell to a viable state.

The principles for warming/thawing are:

1. No manual intervention after placing the storage container with the carrier tool into the machine

2. Removal of the carrier tool from the container

3. Rapid warming and immediate dilution in the appropriate medium

4. Controllable continuous dilution in decreasing concentration of non-permeable cryoprotectants as sucrose

5. Removal of the sample from the carrier tool.

Of course, it will be apparent to a skilled that such a method would also be useful for cryogenic preservation of cells for other uses, for example in preserving stem cells for use in medical procedures.

The method of the present invention may be used for vitrification of cells by cooling at any suitable cooling rate, for example from about 1,000 degrees centigrade per minute to about 40,000 degrees centigrade per minute. Using open-pulled straw (OPS) methods outlined in the video available at (http://www.gaborvajta.com/the-open-pulled-straw-system/), the cooling rate may be more than about 10,000 degrees centigrade per minute. In particular, the cooling rate may be more than about 15,000 degrees centigrade per minute, 20,000 degrees centigrade per minute, 30,000 degrees centigrade per minute, 40,000 degrees centigrade per minute

The conduit may comprise:
at least one inlet and at least one outlet for cryoprotectant and/or diluent to enter and leave the holding space respectively; and
a means in the inlet and outlet capable of maintaining the cell within the holding space.

The means in the inlet and outlet capable of maintaining the cell within the holding space may be a filter. The filter may be placed with the fluid path of the conduit. For example, the filter may be found within the inlet and/or outlet of the conduit. In another example, the filter may be placed outside the inlet and/or outlet. In the latter example, the filter may be placed adjacent to the opening of the inlet and the outlet. For example, the filter may be placed in a container outside of the outlet of the conduit to which the cryoprotectant and/or diluent may be expelled into. There may be a second filter placed in a container outside of the inlet of the conduit to which the cryoprotectant and/or diluent may be introduced into the conduit. The filter may be porous to particles with a cross-section not wider than about 25 μm. In particular, the particles may have a cross-section about 22, 20, 19, 18, 15, 10, 8 μm.

The method of the invention may be used in an automated vitrification system comprising one or more platforms or steps which may be controlled independently. In particular, the steps may be programmatically controlled.

For example, some cells may require different parameters and conditions for equilibration so as to minimize chances of cell damage due to shock from the cryoprotectant which may be cytotoxic, whereas other cells may be more resistant to such cell damage. Accordingly, the method of the invention may comprise one or more independently controllable platforms. Independent control of the platform may include choosing different compositions and concentrations of cryoprotectants for providing to the holding space. It may also include choosing a different amount of time and/or a different method of equilibration, cooling, warming and/or loading the cell into the holding space. The mesh size of the filter may also be chosen depending on the size of the cells in the holding space, for example human oocytes may be about 100 micrometres in diameter and so the filter used may have a mesh size of 25 micrometres, whereas human spermatozoa may have a cross section of about 5 micrometres by 3 micrometres, and a tail 50μm long thus to maintain all spermatozoa in the holding space may require a filter with a mesh size of less than 25 micrometres.

According to another aspect of the present invention, there is provided a device capable of vitrification of at least one cell, the device comprising:
at least one conduit comprising at least one holding space adapted to hold at least one cell;
means for providing at least one fluid to enter the holding space;
means for allowing the fluid to leave the holding space; and
means to maintain the cell within the holding space when the fluid flows through the holding space.

The means to maintain the cell within the holding space when the fluid flows through the holding space may maintain the cell within the holding space when the fluid flows into and out of the holding space. The means to maintain the cell within the holding space when the fluid flows through the holding space may be any porous material. In particular, a filter. There may be at least two filters in the device, a first filter between the holding space and the means for providing at least one fluid to enter the holding space and a second filter between the holding space and the means for allowing the fluid to leave the holding space. The fluid may at least be one cryoprotectant and/or at least one diluent. The conduit may be selected from the group consisting of heat-resistant straw, minitube straw and open pulled straw. The device may further comprise means capable of atomisation of the method of vitrification of the cell. The device may further comprise means capable of automation of the method of vitrification of the cell.

This automated method of vitrification has several unexpected advantages such as:
the versatility of the method to modify parameters (temperature and composition of solutions and incubation parameters);
the possibility to make many individual vitrification procedures in parallel, independently from each other, using individual modules instead of one single machine. This may save up to 90% of the time for vitrification in a busy IVF unit;
biosafety standards as part of the vitrification cycle, the machine may be sterilized with liquid nitrogen for each individual sample; and wraps the sample after vitrification into a hermetically closed container (this was so far a manual process, but 99% of clinics just omitted this step).
the continuous instead of stepwise equilibration and dilution of solutions by using a tube, a filter trap for the samples and a mixture of slowly moving solution with continuously changing composition. This is almost impossible by hand, but can be precisely regulated in the method of the present invention, providing an extremely mild change instead of the usual drastic stepwise equilibration and dilution procedures.
the ability to highly standardize and adjust the time between the last equilibration step and cooling, as well as between the removal from liquid nitrogen and immersion into the thawing solution. This time may be absolutely pre-determined using the method and/or device of the present invention, but none of the available methods can provide a consistent timing; with serious consequences on the consistency of outcome, as well.

Further, current vitrification procedures in embryology laboratories do not meet the basic work safety requirements, as the contradiction between the strict rules of liquid nitrogen handling (clothing, gloves, safety glasses) and the requirements of delicate embryology work (microscopes, pipetting) seem to be incompatible. However, the present invention allows for safe and effective vitrification.

Current vitrification procedures also provide outcomes which are largely dependent on the skills of the operator, whereas the present invention allows for consistent repeatable vitrification.

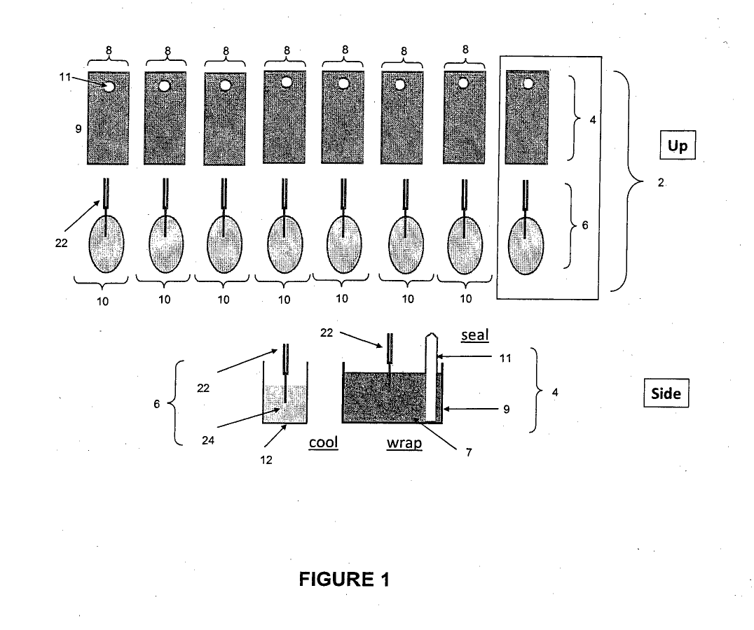

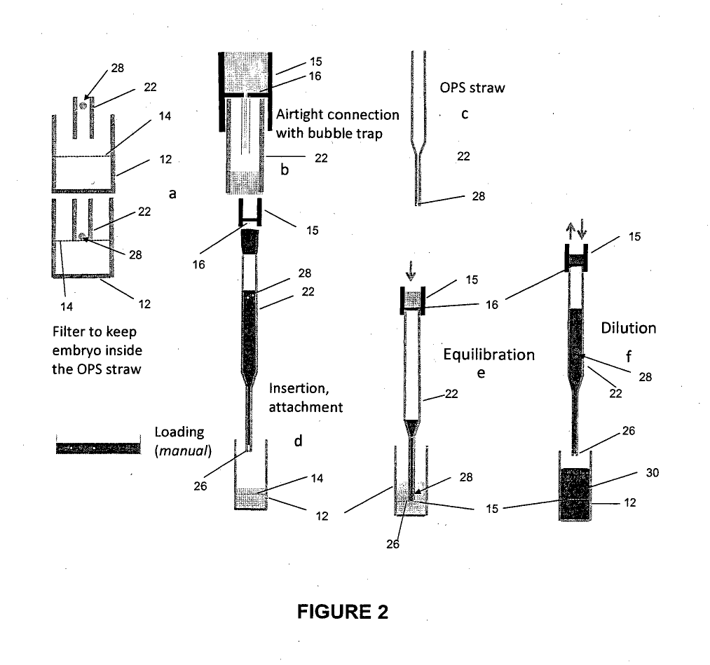

FIGS. 1 and 2 show one embodiment of a fully automated vitrification machine that performs all the related steps (stepwise equilibration, loading (except for loading into the wide end of the straws which is an easy routine procedure), cooling, warming, expelling, dilution) without human intervention, by using adjustable values for variable parameters. The machine offers a highly standardised procedure with adjustable values. It is biologically safe, prevents cross/contamination of samples, and it is also safe for the operator—in contrast to all previous vitrification methods.

The machine has at least 8 sections, each section 2 capable of vitrifying at least one sample of cells. Each section 2 has two parts. In part 1, in FIG. 1, there is a cooling row 4 and an equilibration-dilution row 6. The cooling row 4 has many cooling units 8. Each cooling unit 8 is a stainless steel container 9 with a lid equipped with an UV light, a LN2 level detector, and a tube connected to a LN2 container 9 for automatic refill (not shown). There is also a holder 11 to hold each carrier straw 22.

The equilibration-dilution row 6 comprises an equal number of equilibrium-dilution units 10 as cooling units 8. FIG. 2 shows that each equilibrium-dilution unit 10 comprises at least three parts:
a sterile disposable bottom container 12 equipped with a first filter 14 with pore sizes of approx 25 μm
a sterile disposable upper tube attachment 15 equipped with a second filter 16 with pore sizes of approx 25 μm, the other end is connected to a pump and (in case of equilibration) to standard equilibration solutions (not shown).
a carrier straw 22 (similar to the Open Pulled Straws, OPS, Vajta et al., 1997, 1998).

The cooling unit 8 is adjacent to the equilibrium-dilution unit 10. The temperature of the equilibration-diluton row 6 can be adjusted to 25-37° C.

When in use, there are three main steps—loading, equilibration and cooling. By using the automated program, the bottom container 12 is filled with holding medium 24. The carrier straw 22 is then filled with holding medium 24 by placing the straw 22 in a vertical position into the equilibrium-dilution unit 10, with one end tightly connected to the first filter 14. The sample 28 is loaded into the straw from the top as shown in FIG. 2(d). The upper tube 15 is tightly attached to the straw 22.

The automatic program starts filling LN2 container with LN2 9 then starting UV illumination and pumping down increasing concentration of cryoprotectants for mild equilibration (FIG. 2(e)). Air is then pumped into the straw 22 after equilibration to expel excess amount of cryoprotectants from the carrier straw 22. Once the required amount of cryoprotectants is in the straw, the expulsion of air in the straw 22 stops. With a short inverse suction the sample (i.e. embryos) 28 from the first filter 14 proceeds slightly along the straw 22. The upper tube 15 is opened to air to avoid pressure problems at the future temperature changes. The UV is then stopped and the lip of the LN2 container 9 is opened and the straw 22 is quickly lifted and immersed into the LN2 of the LN2 container 9. After a few seconds, the carrier straw 22 is removed from the holder 11 manually, and placed into the pre-cooled container straw (Vajta et al., 1998) (not shown), that is sealed and stored in a different place. Alternatively, hermetic wrapping-sealing can also be done automatically.

For converting the vitrified cell to a viable cell, two steps warming and dilution are carried out. By using the automated program, the LN2 container 9 is filled with LN2 (no UV sterilization is required). By using the same automated program, the bottom container 12 is filled with a warming medium 30. The container straw (not shown) is then added to the LN2, the upper part is cut and the carrier straw 22 slightly removed to connect tightly to the upper tube 15. The automatic program is then started that removes the carrier straw 22 from the container straw (not shown) and the carrier straw 22 is then immersed quickly into the warming medium 30. The upper tube 15 which has been so far kept open to air to avoid pressure problems is then closed. The warming medium 30 is aspirated to dilute cryoprotectants (FIG. 2(f)). The movement is reversed and dilution continues while samples 28 are at the first filter 14. Dilution of the warming medium 30 is does slowly and continuously. After the appropriate dilution, the solution is reversed again to remove samples 28 from the first and second filters 14, 16. The carrier straw 22 may be removed manually, and sample 28 expelled into a dish (not shown) or the machine changes the dish with another one without filter, and expels the sample into the dish.

This automated method may allow for the following advantages:
Parallel vitrification and warming of up to 8 (or even more) samples
Highly consistent, continuous equilibration and dilution with individual concentration variations
Economical use of LN2
Elimination of contamination problems
Elimination of work-safety issues.

### REFERENCES

Rall W F, Fahy G M. Ice-free cryopreservation of mouse embryos at −196 degrees C. by vitrification. Nature 1985; 313: 573-575

Vajta G. Vitrification in human and domestic animal embryology: work in progress. .Reprod Fertil Dev. 2012 Aug. 10. doi: 10.1071/RD12118.

1. A method of producing at least one vitrified cell comprising:
loading a cell into a holding space in at least one conduit;
providing at least one cryoprotectant to the holding space of the conduit in increasing concentrations, wherein the cryoprotectant is capable of equilibrating the cell;
cooling the cell in the holding space of the conduit to produce a vitrified cell; and
storing and maintaining the vitrified cell in the holding space of the conduit.

2. The method according to claim 1, wherein the holding space of the conduit is capable of being used for thawing the vitrified cell to a viable cell.

3. The method according to claim 2, wherein thawing comprises the steps of:
warming the vitrified cell in the holding space of the conduit; and
providing at least one diluent to the holding space of the conduit in increasing concentrations, wherein the diluent is capable of equilibrating the cell and decreasing the concentration of the cryoprotectant.

4. The method according to claim 1, wherein the holding space is less than about 10 microlitres.

5. (canceled)

6. The method according to claim 1, wherein the conduit comprises:
at least one inlet and at least one outlet for cryoprotectant and/or diluent to enter and leave the holding space respectively; and
a means in the inlet and/or outlet capable of maintaining the cell within the holding space.

7. The method according to claim 6, wherein the means in the inlet and outlet is at least one filter.

8. The method according to claim 7, wherein the filter is porous to particles with a cross-section not wider than about 25 μm.

9. The method according to claim 1, wherein the cell is selected from the group consisting of embryo, oocyte and spermatozoon.

10. The method according to claim 1, wherein the cryoprotectant is selected from the group consisting of ethylene glycol, propylene glycol, glycerol, dimethyl sulfoxide and sucrose.

11. The method according to any one of the preceding claims claim 1, wherein the providing of cryoprotectant in increasing concentrations to the holding space is done in a stepwise or continuous manner.

12. The method according to claim 3, wherein the providing of diluent in increasing concentrations to the holding space is done in a stepwise or continuous manner.

13. The method according to claim 1, wherein the cooling of the cell and/or the warming of the vitrified cell is at a rate of at least about 15,000 degrees centigrade per minute.

14. (canceled)

15. The method according to claim 1, wherein the conduit is selected from the group consisting of heat-resistant straw, minitube straw and open pulled straw.

16. The method according to claim 1, wherein the steps are programmatically controlled.

17. A device capable of vitrification of at least one cell, the device comprising:
at least one conduit comprising at least one holding space adapted to hold at least one cell;
means for providing at least one fluid to enter the holding space;
means for allowing the fluid to leave the holding space; and
means to maintain the cell within the holding space when the fluid flows through the holding space.

18. The device according to claim 17, wherein the means to maintain the cell within the holding space when the fluid flows through the holding space is a filter.

19. The device according to claim 18, wherein there are at least two filters, a first filter between the holding space and the means for providing at least one fluid to enter the holding space and a second filter between the holding space and the means for allowing the fluid to leave the holding space.

20. The device according to claim 19, wherein the fluid comprises at least one cryoprotectant and/or at least one diluent.

21. The device according to claim 20, wherein the conduit is selected from the group consisting of heat-resistant straw, minitube straw and open pulled straw.

22. The device according to claim 21, further comprising means capable of automation of the method of vitrification of the cell.
